(19) United States
(12) Patent Application Publication
(10) Pub. No.: US 2025/0303710 A1
(43) Pub. Date: Oct. 2, 2025

(54) LIQUID EJECTION HEAD AND LIQUID EJECTION APPARATUS

(71) Applicant: CANON KABUSHIKI KAISHA, Tokyo (JP)

(72) Inventor: ASUKA HORIE, Kanagawa (JP)

(21) Appl. No.: 19/096,955

(22) Filed: Apr. 1, 2025

(30) Foreign Application Priority Data
Apr. 2, 2024 (JP) 2024-059534

(51) Int. Cl. B41J 2/14

(52) U.S. Cl. CPC B41J 2/14

(57) ABSTRACT

A technique that can suppress the occurrence of jamming between a configuration that supports a printing element substrate and a configuration that guides a leading edge of a curled print medium is to be provided. An element substrate configured to eject liquid from ejection ports, a support member configured to support the element substrate, and a cover member configured to cover the element substrate are included, wherein the cover member includes a flat part equipped with an opening through which the ejection ports are exposed to the outside, and an inclined part provided on at least one side of the flat part so as to incline toward the support member as the inclined part extends away from the flat part, and wherein the support member includes a recessed part configured to accommodate a leading edge of the inclined part.

### BACKGROUND OF THE INVENTION

### Field of the Invention

The present disclosure relates to a liquid ejection head and a liquid ejection apparatus.

### Description of the Related Art

Japanese Patent Laid-Open No. 2022-168641 discloses a liquid ejection head including a cover member that covers a flexible wiring substrate connected to a printing element substrate, which is supported by a support member, with the ejection ports of the printing element substrate being exposed to the outside. This cover member has a guide part, which is formed on the upstream side of the conveyance direction of the print medium and is inclined so as to guide the print medium, whose leading edge portion is curved (curled), from the leading edge into the space between the liquid ejection head and the support part (the platen) during conveyance.

In the liquid ejection head disclosed in Japanese Patent Laid-Open No. 2022-168641, configurations for the position where the protective member and guide part are adjacent to each other on the upstream side of the conveyance direction are disclosed, which include a configuration for reducing the gap between the protective member and the guide part, a configuration for overlapping the protective member and the guide part, and a configuration for sealing with a sealant. However, in the configuration with the gap, there is a possibility that the leading edge of the curled print medium may enter the gap and cause a jam. Further, in the overlapping configuration, a vertical surface is formed near the guide part, and there is a possibility that the leading edge of the curled print medium may be guided by this surface toward the protective member side and cause a jam. Furthermore, in the configuration with the sealing with a sealant, a convex part is formed by the sealant, and there is a possibility that the leading edge of the curled print medium may get caught in the convex part and cause a jam.

### SUMMARY OF THE INVENTION

The present disclosure has been made in consideration of the above-mentioned problems, and provides a technique that can suppress the occurrence of jamming between a configuration that supports a printing element substrate and a configuration that guides the leading edge of a curled print medium.

A liquid ejection head includes: an element substrate configured to eject liquid from ejection ports; a support member configured to support the element substrate; and a cover member configured to cover the element substrate, wherein the cover member includes a flat part equipped with an opening through which the ejection ports are exposed to the outside, and an inclined part provided on at least one side of the flat part so as to incline toward the support member as the inclined part extends away from the flat part, and wherein the support member includes a recessed part configured to accommodate a leading edge of the inclined part.

According to the present disclosure, it is possible to suppress the occurrence of jamming between a configuration that supports a printing element substrate and a configuration that guides the leading edge of a curled print medium.

Further features of the present invention will become apparent from the following description of exemplary embodiments with reference to the attached drawings.

### BRIEF DESCRIPTION OF THE DRAWINGS

FIG. 1 is a schematic configuration diagram of a liquid ejection apparatus;

FIG. 2A and FIG. 2B are external views of a liquid ejection head;

FIG. 3A and FIG. 3B are schematic configuration diagrams of a cover member;

FIG. 4A and FIG. 4B are schematic configuration diagrams of a liquid ejection part;

FIG. 5A and FIG. 5B are diagrams illustrating change in a curled print medium during conveyance in a comparative example;

FIG. 6A and FIG. 6B are diagrams illustrating change in a curled print medium during conveyance in an embodiment;

FIG. 7 is a schematic configuration diagram of a liquid ejection apparatus according to another embodiment;

FIG. 8A and FIG. 8B are schematic configuration diagrams of a cover member;

FIG. 9 is a schematic configuration diagram of a liquid ejection part;

FIG. 10A and FIG. 10B are diagrams illustrating change in a curled print medium during conveyance in an embodiment;

FIG. 11 is a diagram illustrating a modification example of a recessed part provided in a support member; and

FIG. 12 is a diagram illustrating the state in which a resin material is placed in the recessed part.

### DESCRIPTION OF THE EMBODIMENTS

Hereinafter, with reference to the accompanying drawings, a description is given of an example of embodiments of a liquid ejection head and a liquid ejection apparatus. Note that it is not intended that the following embodiments limit the present disclosure, and every combination of the characteristics explained in the present embodiments is not necessarily essential to the solution provided in the present disclosure. Further, the positions, shapes, etc., of the constituent elements described in the present embodiments are merely examples and are not intended to limit this invention thereto.

### First Embodiment

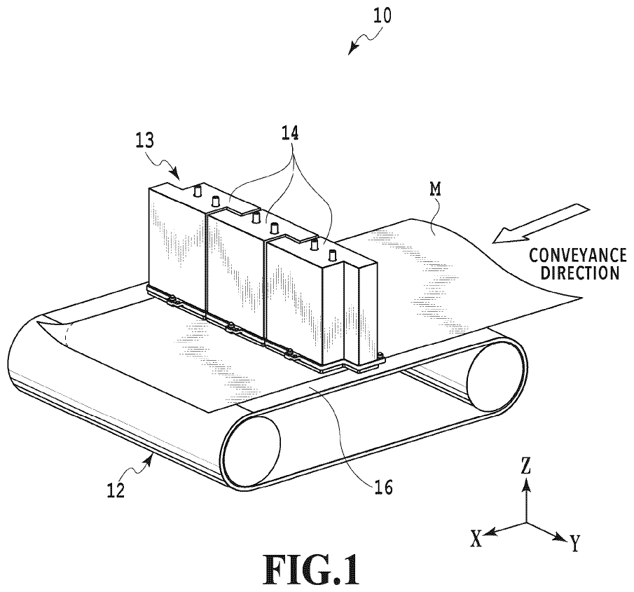

First, with reference to FIG. 1 to FIG. 6B, a description is given about the liquid ejection head according to the first embodiment.

### <Configuration of the Liquid Ejection Apparatus>

First, a description is given about the gist of the configuration of a liquid ejection apparatus equipped with a liquid ejection head according to the present embodiment. In the following description, as an example, a description is given about a liquid ejection apparatus equipped with a liquid ejection head that ejects ink, or a liquid, for performing printing on a print medium by ejecting ink from the liquid ejection head. Note that the liquid ejected from the liquid ejection head is not limited to ink, but includes a processing liquid that performs a predetermined process on the ink ejected onto the print medium. Further, in the description of the present embodiment, it is assumed that the conveyance direction of the print medium is the X direction, the width direction of the print medium perpendicular to the X direction is the Y direction, and the direction perpendicular to both the X direction and the Y direction is the Z direction. Furthermore, for ease of understanding, the liquid ejection head is explained in the orientation in which it is mounted on the liquid ejection apparatus.

FIG. 1 is a schematic configuration diagram of the liquid ejection apparatus. The liquid ejection apparatus 10 in FIG. 1 is equipped with the conveyance part 12 that conveys the print medium M, and the printing part 13 that performs printing by ejecting ink onto the print medium M conveyed by the conveyance part 12. The conveyance part 12 is configured to convey the print medium M in the X direction, and is equipped with the support part (platen) 16 that supports the print medium M being conveyed.

The printing part 13 is equipped with a plurality of the liquid ejection heads 14. In the printing part 13, the multiple liquid ejection heads 14 are arrayed in the Y direction so as to correspond to the length in the width direction of the print medium M conveyed by the conveyance part 12. That is, in the present embodiment, the printing part 13 is equipped with a full-line type head unit that is configured with the multiple liquid ejection heads 14. To each of the liquid ejection heads 14, for example, ink stored in an ink tank (not illustrated in the drawings) is supplied via a tube (not illustrated in the drawings). Note that the printing part 13 is not limited to having a plurality of the liquid ejection heads 14. For example, the printing part 13 may be configured with one liquid ejection head 14 that has a length corresponding to the length of the print medium M in the width direction.

In the liquid ejection apparatus 10, for example, while the conveyance part 12 conveys a plurality of the print media M continuously or intermittently, the liquid ejection head 14 can continuously perform printing on the print media M. The print media used in the liquid ejection apparatus 10 include, not only paper such as cut paper or roll paper, but also cloth, plastic films, metal plates, glass, ceramics, wood, leather, and the like that can accept ink.

### <Configuration of the Liquid Ejection Head>

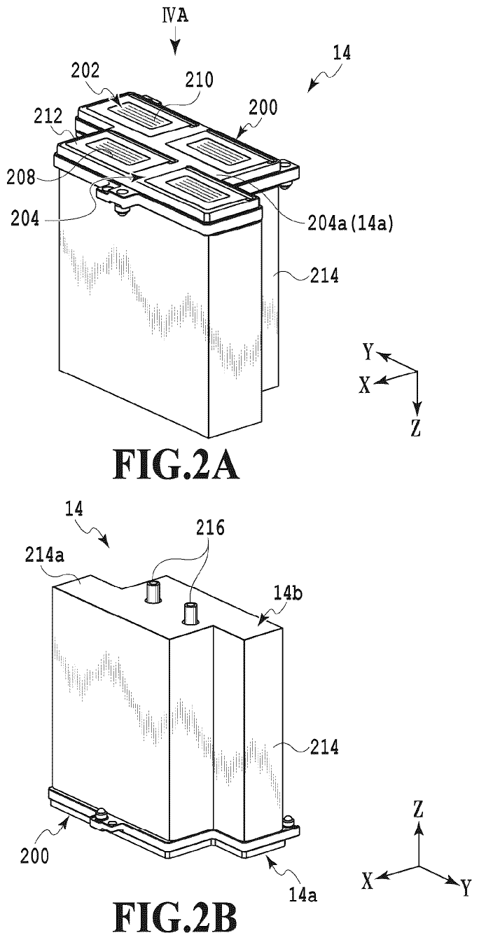

Next, a description is given about the configuration of the liquid ejection heads 14. FIG. 2A and FIG. 2B are external views of the liquid ejection head 14, with FIG. 2A being a perspective view seen from the bottom surface side facing the support part 16 of the conveyance part 12 and FIG. 2B being a perspective view seen from the top side.

The liquid ejection head 14 includes the liquid ejection part 200 that is equipped with a configuration for ejecting ink (See FIG. 2A). In the liquid ejection apparatus 10, the liquid ejection head 14 is arranged so that the support part 16 of the conveyance part 12 and the liquid ejection part 200 face each other during printing. The liquid ejection part 200 includes the printing element substrates (hereinafter also referred to as the “element substrates”) 202 in which the ejection ports 210 that eject ink are formed, and the support member 204 that supports the printing element substrates 202. Further, the liquid ejection part 200 is equipped with the cover members 212 that each covers the printing element substrate 202 such that a predetermined area including the ejection ports 210 is exposed to the outside through the opening 208. Therefore, the bottom surface 14a of the liquid ejection head 14 includes the front surface 204a of the support member 204 that faces the support part 16, the cover members 212, and the predetermined areas that includes the ejection ports 210 in the printing element substrates 202.

In the liquid ejection head 14, a flow path (not illustrated in the drawings) for supplying liquid to the liquid ejection part 200, electrical wiring (not illustrated in the drawings) for communicating power and drive signals to the liquid ejection part 200, and the like are installed within the head cover 214. On the upper surface 214a of the head cover 214 that forms the top surface 14b of the liquid ejection head 14, the liquid introduction parts 216 for introducing ink into the liquid ejection part 200 via the flow path are installed (See FIG. 2B). The liquid introduction parts 216 are connected via a tube to an ink tank that stores ink. In the present embodiment, the configuration including two of the liquid introduction parts 216 is illustrated as an example, but the number of the liquid introduction parts 216 may be one, or three or more. Further, in a case of a configuration in which ink is circulated in the liquid ejection head 14, one of the liquid introduction parts 216 serves to introduce ink, and the other serves to discharge ink.

In the present embodiment, in one liquid ejection head 14, four printing element substrates 202 are arranged in a staggered manner in the liquid ejection part 200, and the cover members 212 are installed independently for the respective printing element substrates 202. Note that the number of printing element substrates 202 in the liquid ejection part 200 is not limited to four, but may be one, two, three, or five or more. Further, the arrangement of the printing element substrates 202 in the liquid ejection part 200 is not limited to the staggered manner, but may an arrangement in an array in the extending direction of the liquid ejection head 14 (the Y direction in the present embodiment), for example.

### <Configuration of the Liquid Ejection Part>

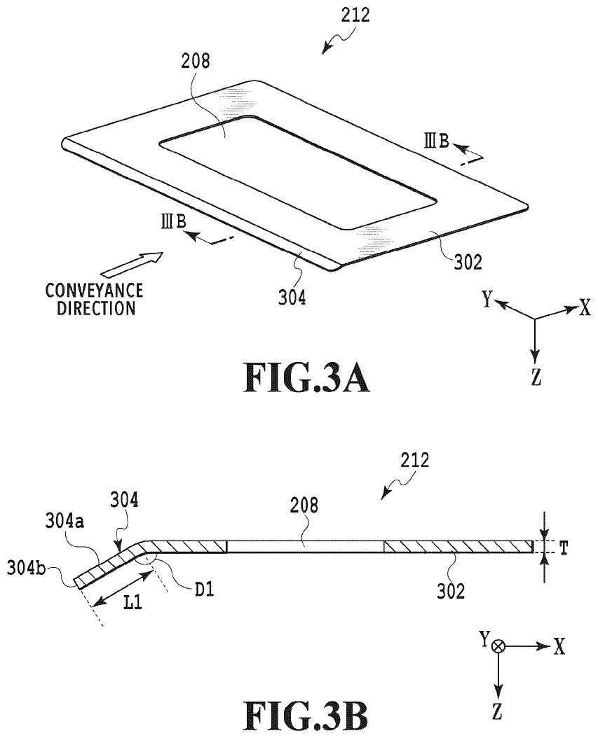

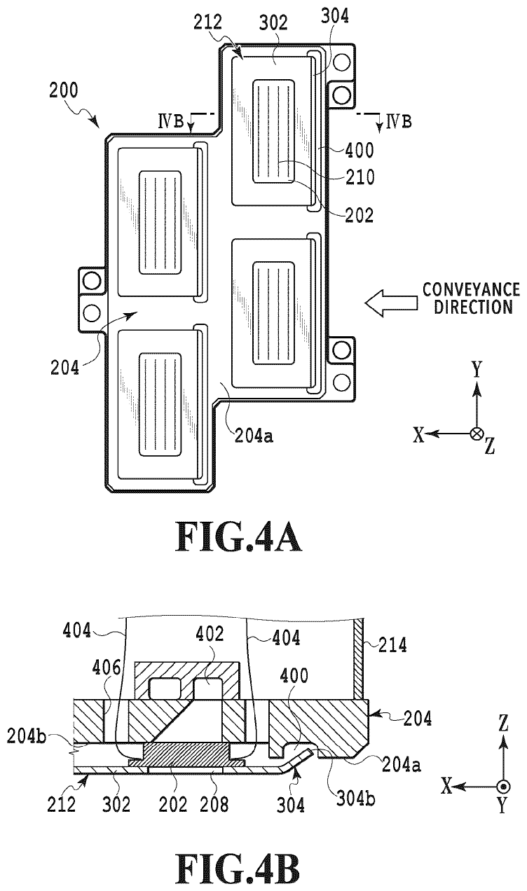

Next, a description is given about the configuration of the liquid ejection part 200. FIG. 3A and FIG. 3B are schematic configuration diagrams of the cover member 212, with FIG. 3A being a perspective view of the cover member 212 and FIG. 3B being a cross-sectional view taken along line IIIB-IIIB of FIG. 3A. FIG. 4A and FIG. 4B are schematic configuration diagrams of the liquid ejection part 200, with FIG. 4A being an arrow view in IVA of FIG. 2A, and FIG. 4B being a cross-sectional view taken along line IVB-IVB of FIG. 4A.

### =Cover Member=

The cover member 212 installed in the liquid ejection part 200 is equipped with the plate-shaped flat part 302 and the guide part (hereinafter also referred to as the “inclined part”) 304 formed at an incline relative to the flat part 302 on the upstream side of the flat part 302 in the conveyance direction (See FIG. 3A). The opening 208 is provided in the approximate center portion of the flat part 302. Although details are described later, the guide part 304 is configured to guide the leading edge of the print medium conveyed in the conveyance direction. The guide part 304 is formed so as to gradually incline in the +Z direction toward the upstream side in the conveyance direction. Therefore, in a case where the cover member 212 is installed on the printing element substrate 202, the guide part 304 is formed so as to incline toward the support member side as it extends away from the flat part 302. The guide part 304 is formed over the entire area of one side of the flat part 302 extending in the Y direction. The guide surface 304a of the guide part 304 on which the conveyed print medium M can abut may be a flat surface (See FIG. 3B) or a curved surface. Hereinafter, the “guide surface” is also referred to as the “inclined surface.” The length L1 of the guide part 304 is made so that, in a case where the cover member 212 is placed on the printing element substrate 202, the leading edge 304b of the guide part 304 is accommodated in the groove-shaped recessed part (the groove part 400 described later) provided on the front surface 204a of the support member 204. Note that the length of the guide part 304 accommodated in the groove part 400 is described later.

The thickness T of the cover member 212 greatly affects the distance between the print medium M (or the support part 16) and the ejection ports 210 at the time the liquid ejection head 14 is installed in the liquid ejection apparatus 10. In other words, if the thickness T of the cover member 212 is thin, the distance between the print medium M and the ejection ports 210 can be reduced. Therefore, the thinner the thickness T, the higher the accuracy of drawing with ink can be improved. Further, from the viewpoint of strength, the material of the cover member 212 is preferably metal. For these reasons, in the present embodiment, the cover member 212 is made of titanium and the thickness T is 0.1 mm.

### =Support Member=

The support member 204 that supports the printing element substrates 202 is equipped with the support surface 204b that supports each printing element substrate 202 at a position recessed from the front surface 204a of the support member 204 (See FIG. 4B). The printing element substrate 202 supported by the support surface 204b faces the support part 16 of the conveyance part 12 at the time the liquid ejection head 14 is installed in the liquid ejection apparatus 10. Further, the support member 204 is equipped with the flow path 402 for introducing ink into the printing element substrate 202 (See FIG. 4B). As a result, the ink introduced via the liquid introduction parts 216 is supplied to the printing element substrate 202 via the flow path in the head cover 214 and the flow path 402.

The support member 204 is equipped with the hole parts 406 through which the flexible wiring substrate 404 that connects the electric wiring contained in the head cover 214 and the printing element substrate 202 is inserted (See FIG. 4B). Each printing element (not illustrated in the drawings) installed on the printing element substrate 202 is connected to, for example, a control part (not illustrated in the drawings) that controls the liquid ejection apparatus 10 via the electrical wiring and the flexible wiring substrate 404. This makes it possible to communicate power and drive signals from the control part to each printing element via the electric wiring, the flexible wiring substrate 404, etc. Note that the printing elements are elements that are installed on the printing element substrates 202 and generate energy for ejecting ink from the ejection ports 210, and various known elements such as electrothermal conversion elements and electromechanical conversion elements can be used, for example.

On the upstream side of each printing element substrate 202 in the conveyance direction, the groove part 400 capable of accommodating the leading edge 304b of the guide part 304 in the cover member 212 arranged on the printing element substrate 202 is formed on the front surface 204a of the support member 204 (See FIG. 4A and FIG. 4B).

### <Jamming Suppression>

With the above configurations, in a case of printing in the liquid ejection apparatus 10, the print medium M is conveyed by the conveyance part 12, and at a position facing the liquid ejection head 14, the print medium M is conveyed in a state being supported by the support part 16. Hereinafter, a description is given about the jamming suppression effect provided by the present embodiment.

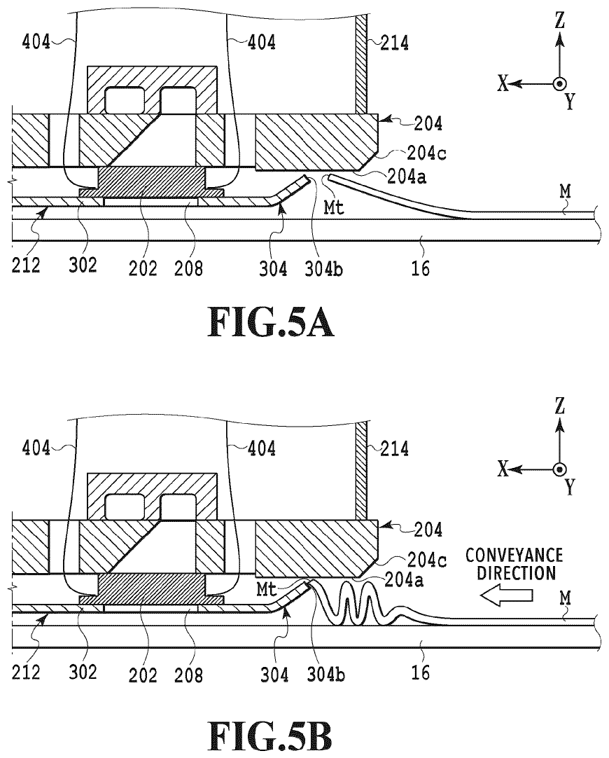

First, with reference to FIG. 5A and FIG. 5B, a description is given about the occurrence of jamming in a liquid ejection head of a comparative example in which the groove part 400 is not provided and the leading edge 304b of the guide part 304 is positioned near the front surface 204a of the support member 204. FIG. 5A and FIG. 5B are diagrams for explaining, as a comparative example, jamming that occurs in the liquid ejection head in which the groove part 400 is not provided. FIG. 5A is a diagram illustrating the state immediately before the conveyed print medium M abuts on the guide part, and FIG. 5B is a diagram illustrating the state where jamming has occurred due to the guide part.

In a case where the groove part 400 is not provided, the print medium M, with a curled leading edge portion, first abuts on the support member 204 at the leading edge Mt as it is conveyed by the conveyance part 12. Note that, in the present embodiment, the leading edge Mt of the print medium M refers to the edge part of the print medium M on the downstream side in the conveyance direction. Specifically, the leading edge Mt first abuts on the inclined surface 204c of the support member 204, then travels along the inclined surface 204c as it is conveyed, and then reaches the front surface 204a of the support member 204 (See FIG. 5A). Thereafter, as it is further conveyed by the conveyance part 12, the leading edge Mt travels along the front surface 204a and abuts on the leading edge 304b of the guide part 304 in the vicinity of the front surface 204a, or enters the space between the leading edge 304b and the front surface 204a. As a result, the print medium M is not guided into the space between the liquid ejection head 14 (the cover member 212) and the support part 16, and the print medium M deforms on the upstream side of the space in the conveyance direction as it is conveyed, causing jamming (See FIG. 5B).

In a case where jamming occurs during printing, it is necessary to stop the printing operation in order to remove the print medium M on which the jamming has occurred. Further, in a case where the leading edge Mt of the print medium M abuts on the leading edge 304b of the guide part 304, the impact at the time of abutment may damage the printing element substrate 202 to which the cover member 212 equipped with the guide part 304 is attached. Moreover, in a case where the leading edge Mt enters between the leading edge 304b and the front surface 204a, the leading edge Mt may come into contact with the printing element substrate 202, and the impact at that time may damage the printing element substrate 202. Furthermore, if the leading edge Mt enters between the leading edge 304b and the front surface 204a, the leading edge Mt coming into contact with the flexible wiring substrate 404, or the impact at that time, may damage the connecting portion between the printing element substrate 202 and the flexible wiring substrate 404.

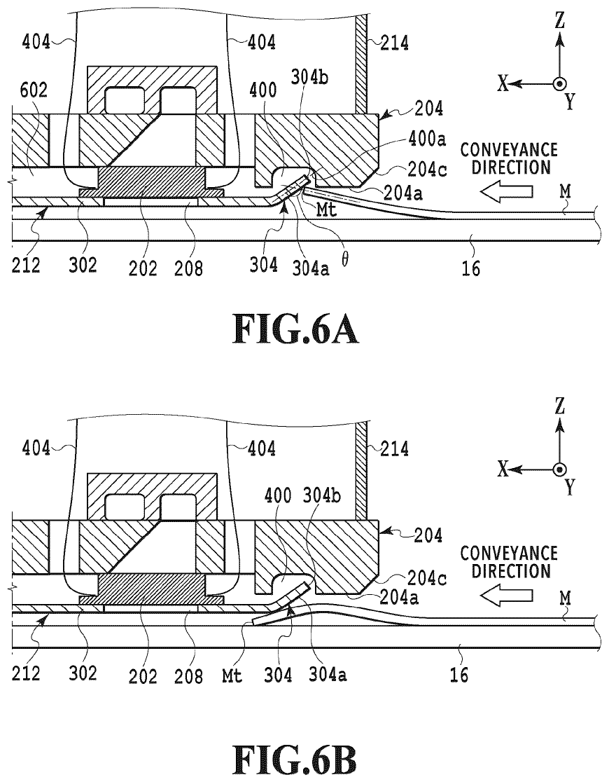

Next, a description is given about the effect of suppressing jamming by the liquid ejection head 14 equipped with the configuration according to the present embodiment. FIG. 6A and FIG. 6B are diagrams for explaining how jamming is suppressed by the liquid ejection head 14. FIG. 6A is a diagram illustrating the state immediately before the conveyed print medium M abuts on the guide part 304, and FIG. 6B is a diagram illustrating the state where the print medium M is guided by the guide part 304.

In a case where the leading edge portion of the print medium M is curled, the leading edge Mt of the print medium M first abuts on the support member 204 as it is conveyed by the conveyance part 12. In the present embodiment, the leading edge Mt first abuts on the inclined surface 204c of the support member 204, then travels along the inclined surface 204c as it is conveyed, and then reaches the front surface 204a of the support member 204. Thereafter, as it is further conveyed by the conveyance part 12, the leading edge Mt travels along the front surface 204a and reaches the groove part 400. Upon reaching the groove part 400, the leading edge Mt abuts on the guide surface 304a of the guide part 304 whose leading edge 304b is accommodated within the groove part 400 (See FIG. 6A).

The guide surface 304a of the guide part 304, which is the surface where the print medium can abut, is formed so as to gradually incline in the −Z direction (downward in FIG. 5A and FIG. 5B) as it travels in the conveyance direction (the +X direction). Therefore, the leading edge Mt that has abutted on the guide surface 304a is gradually guided along the guide surface 304a in the −Z direction, where the support part 16 is positioned, as the print medium M is further conveyed by the conveyance part 12, and is guided into the space between the cover member 212 and the support part 16 (See FIG. 6B).

Note that the leading edge Mt of the print medium M, which is curled at the leading edge portion, travels along the front surface 204a as described above, and reaches the guide part 304 whose leading edge 304b is positioned within the groove part 400. Thus, if the distance between the wall surface 400a on the upstream side of the groove part 400 in the conveyance direction and the leading edge 304b of the guide part 304 that is accommodated within the groove part 400 is too far, the leading edge Mt may enter between the wall surface 400a and the leading edge 304b, depending on the degree of curling of the leading edge portion. Therefore, for example, in the groove part 400, the wall surface 400a and the leading edge 304b may be designed to abut on each other. Alternatively, the wall surface 400a and the leading edge 304b may be separated in the conveyance direction (the X direction) by a predetermined distance based on the curl tolerance level, so that the leading edge Mt, upon reaching the groove part 400 after traveling along the front surface 204a, does not enter the groove part 400. Note that, in the present embodiment, the leading edge portion of the print medium M refers to a portion of the print medium M within a predetermined range from the leading edge Mt, including the leading edge Mt.

Further, the inclination angle D1 (See FIG. 3B) of the guide part 304 relative to the flat part 302 is an angle that allows the leading edge Mt of the print medium M to be guided between the cover member 212 and the support part 16 after the leading edge Mt comes into contact with the guide surface 304a. Specifically, for example, D1 is formed so that, at the time the leading edge Mt abuts on the guide surface 304a after traveling along the front surface 204a, the angle θ made by the guide surface 304a and the curled leading edge portion of the print medium M is an obtuse angle. Note that, in a case where the guide surface 304a is a curved surface, for example, DI is formed so that the angle made by the leading edge portion and the tangent line at the contact position (and in its vicinity) of the leading edge Mt and the guide surface 304a is an obtuse angle. Therefore, the length of the guide part 304 accommodated in the groove part 400 is set to a predetermined length that satisfies the above-described conditions and allows the leading edge Mt of the print medium M to abut on the guide surface 304a at the time the leading edge Mt enters the groove part 400 after traveling along the front surface 204a.

As a result, with the liquid ejection head 14, even if the leading edge portion of the print medium M is curled, the guide part 304 smoothly guides the print medium M from the leading edge Mt into the space between the liquid ejection head 14 (the cover member 212) and the support part 16. Therefore, jamming caused by the print medium M during conveyance can be suppressed, and printing stoppages due to jamming during printing operations are less likely to occur. Further, in the present embodiment, the groove part 400 is provided at a position corresponding to the guide part 304 of the cover member 212 of each of the four printing element substrates 202 installed in a staggered arrangement. Therefore, after passing through the two printing element substrates 202 positioned on the upstream side in the conveyance direction, even if the print medium M continues to be conveyed with the curl of the leading edge portion of the print medium M being maintained, jamming can also be suppressed at the two printing element substrates 202 positioned on the downstream side in the conveyance direction.

### <Functional Effect>

As explained above, on the upstream side of the cover member 212 in the conveyance direction, the liquid ejection head 14 is equipped with the guide part 304, with which the leading edge Mt of the print medium M whose leading edge portion is curled can be guided between the cover member 212 and the support part 16. Further, the leading edge 304b of the guide part 304 is designed to be accommodated in the groove part 400 provided on the front surface 204a of the support member 204 that supports the printing element substrate 202. Accordingly, the leading edge Mt of the curled print medium M is smoothly guided from the front surface 204a of the support member 204 to the support part 16 side via the guide part 304 as it is conveyed, thereby suppressing the occurrence of jamming.

### Second Embodiment

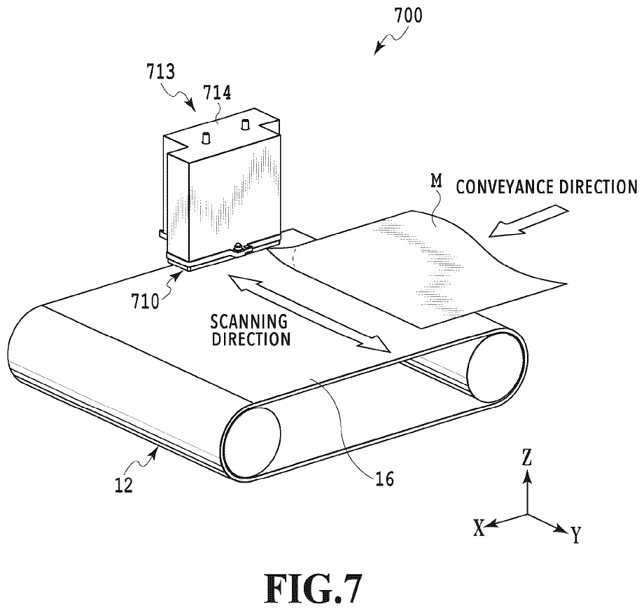

Next, with reference to FIG. 7 to FIG. 10B, a description is given about the liquid ejection head according to the second embodiment. In the following description, the same or corresponding configurations as those of the liquid ejection apparatus according to the first embodiment are assigned with the same signs as those used in the first embodiment, so as to omit detailed descriptions thereof.

The liquid ejection head according to the first embodiment is configured to be compatible with a full-line type liquid ejection apparatus, whereas the liquid ejection head according to the second embodiment is configured to be compatible with a serial scanning type liquid ejection apparatus. Specifically, the liquid ejection head of the present embodiment differs from the liquid ejection head of the first embodiment described above in an aspect that the guide parts are installed on three sides of the cover member 212, i.e., the upstream side in the conveyance direction, and both sides (one side and the other side) in the scanning direction of the liquid ejection head.

### <Configuration of the Liquid Ejection Apparatus>

FIG. 7 is a schematic configuration diagram of a liquid ejection apparatus equipped with a liquid ejection head according to the present embodiment. The liquid ejection apparatus 700 in FIG. 7 includes the conveyance part 12 that conveys the print medium M, and the printing part 713 that performs printing on the print medium M conveyed by the conveyance part 12 while scanning in the direction intersecting (orthogonally in the present embodiment) with the conveyance direction of the print medium M by the conveyance part 12. The printing part 713 is equipped with the liquid ejection head 714. In the printing part 713, the liquid ejection head 14 is installed such that the ejection port array formed by arranging the multiple ejection ports 210 in each printing element substrate 202 intersects with the scanning direction (the Y direction) of the liquid ejection head.

### <Configuration of the Liquid Ejection Head>

Next, a description is given about the configuration of the liquid ejection head 714. Note that, in the following description, differences from the liquid ejection head 14 found in the liquid ejection head 714 are explained, and descriptions about the same configurations are omitted. The liquid ejection head 714 includes the liquid ejection part 710 equipped with a configuration for ejecting ink (See FIG. 7).

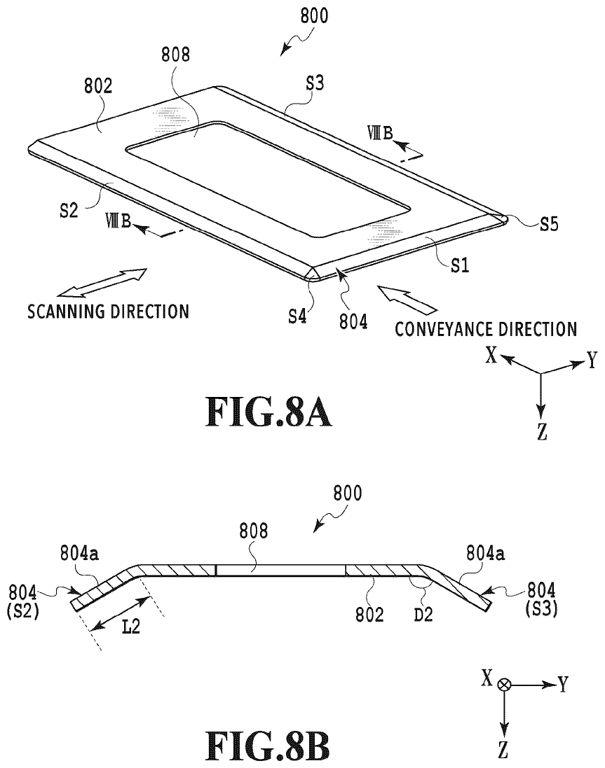

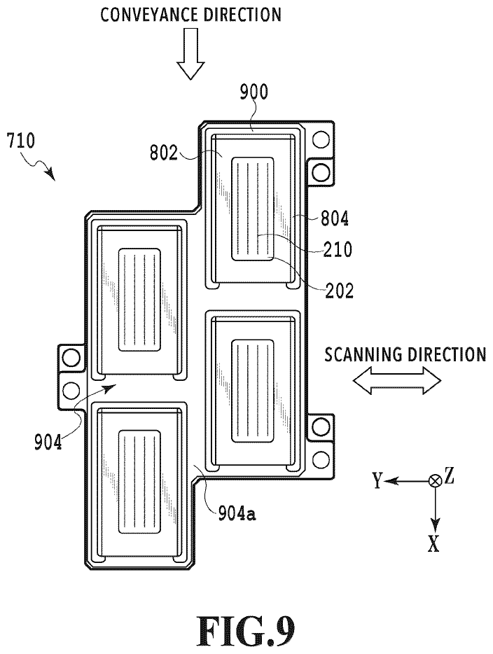

The liquid ejection head 714 is equipped with the cover member 800 which covers the printing element substrate 202 with a predetermined area including the ejection ports 210 being exposed to the outside through the opening 808, and which has the guide part 804 formed therein for guiding the leading edge of the print medium being conveyed. Note that the configuration of the cover member 800 is described later using FIG. 8A and FIG. 8B. Further, the liquid ejection head 714 includes the support member 904 that supports the printing element substrates 202 and is equipped with the groove parts 900 on its front surface for accommodating the leading edges 804b of the guide parts 804 provided in the cover members 800. Note that the configuration of the groove parts 900 formed in the support member 904 is described later using FIG. 9.

### <Configuration of the Liquid Ejection Part>

Next, a description is given about the configuration of the liquid ejection part 710. FIG. 8A and FIG. 8B are schematic configuration diagrams of the cover member 800, with FIG. 8A being a perspective view of the cover member 800 and FIG. 8B being a cross-sectional view taken along line VIIIB-VIIIB of FIG. 8A. FIG. 9 is a bottom surface diagram of the liquid ejection head 714.

### =Cover Member=

The cover member 800 installed on the liquid ejection part 710 is equipped with the plate-shaped flat part 802 and the guide part 804 formed in a continuous shape surrounding three sides of the flat part 802, i.e., the upstream side in the conveyance direction, the one side in the scanning direction, and the other side in the scanning direction (See FIG. 8A). The guide part 804 is formed so as to be inclined relative to the flat part 802.

The opening 808 is provided in the approximate center portion of the flat part 802. In the area S1 provided on the upstream side in the conveyance direction, the guide part 804 is formed so as to gradually incline in the +Z direction toward the upstream side in the conveyance direction. Further, in the area S2 provided on the one side in the scanning direction (the left side in FIG. 8B), the guide part 804 is formed so as to gradually incline in the +Z direction toward the one side in the scanning direction (See FIG. 8B). Furthermore, in the area S3 provided on the other side in the scanning direction (the right side in FIG. 8B), the guide part 804 is formed so as to gradually incline in the +Z direction toward the other side in the scanning direction (see FIG. 8B). Note that the area S1 and the area S2 are connected by the area S4, and the area S1 and the area S3 are connected by the area S5. In the area S4 and the area S5, the guide part 804 is formed so as to gradually incline in the +Z direction as it extends away from the flat part 802. Therefore, in a case where the cover member 800 is installed on the printing element substrate 202, the guide part 804 is formed so as to incline toward the support member side as it extends away from the flat part 802.

The guide surface 804a of the guide part 804 may be a flat surface (See FIG. 8B) or a curved surface. The length L2 of the guide part 804 is made so that, in a case where the cover member 800 is installed on the printing element substrate 202, the leading edge 804b of the guide part 804 is accommodated in the groove part 900 provided in the front surface 904a of the support member 904. Note that the length of the guide part 804 accommodated in the groove part 900 is described later.

### =Support Member=

Next, a description is given about the support member 904 that supports the printing element substrates 202, but in the following description, only the differences from the support member 204 are explained. The groove parts 900 capable of accommodating the leading edges 804b of the guide parts 804 of the cover members 800 installed on the printing element substrates 202 are formed on the front surface 904a of the support member 904 (See FIG. 9). Specifically, the groove parts 900 are each formed so as to surround the upstream side in the conveyance direction, the one side in the scanning direction, and the other side in the scanning direction of the printing element substrate 202 supported by the support member 904.

### <Jamming Suppression>

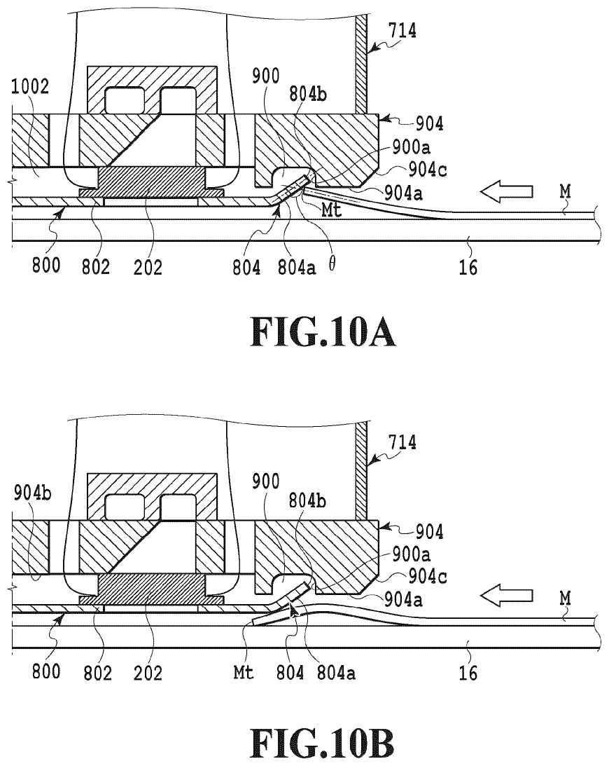

Next, a description is given about the effect of suppressing jamming by the liquid ejection head 714 equipped with the configurations according to the present embodiment. FIG. 10A and FIG. 10B are diagrams for explaining the suppression of jamming in the liquid ejection head 714. FIG. 10A is a diagram illustrating the state immediately before the print medium M abuts on the guide part 804 due to the relative movement between the print medium M and the liquid ejection head 714. FIG. 10B is a diagram illustrating the state in which the print medium M is guided by the guide part 804 due to the relative movement between the print medium M and the liquid ejection head 714. Note that the hollow arrows in FIG. 10A and FIG. 10B indicate the direction of the relative movement of the print medium M with respect to the liquid ejection head 714 (that is, the conveyance direction and the scanning direction).

In a case where the leading edge portion of the print medium M is curled, the leading edge Mt of the print medium M first abuts on the support member 904 as it is conveyed by the conveyance part 12 and scanned by the liquid ejection head 714. That is, in the present embodiment, the leading edge Mt first abuts on the inclined surface 904c of the support member 904, then travels along the inclined surface 904c as it is conveyed and scanned, and then reaches the front surface 904a of the support member 904. Note that, in the present embodiment, the leading edge Mt of the print medium M includes the end portion of the print medium M on the downstream side in the conveyance direction, and the end portion on one side and the end portion on the other side of the print medium M in the width direction (the scanning direction). Thereafter, as it is conveyed by the conveyance part 12 and scanned by the liquid ejection head 714, the leading edge Mt travels along the front surface 904a and then reaches the groove part 900. The leading edge Mt that has reached the groove part 900 abuts on the guide surface 804a of the guide part 804 whose leading edge 804b is accommodated within the groove part 900 (See FIG. 10A).

The guide surface 804a is formed so as to gradually incline in the −Z direction (downward in FIG. 10A and FIG. 10B) from the leading edge 804b toward the flat part 802. Therefore, the leading edge Mt that has abutted on the guide surface 804a is gradually guided along the guide surface 804a in the −Z direction, where the support part 16 is positioned, as the print medium M is further conveyed by the conveyance part 12 and further scanned by the liquid ejection head 714. As a result, the leading edge Mt is guided into the space between the cover member 800 and the support part 16 (See FIG. 10B).

Note that the leading edge Mt of the print medium M with a curled leading edge portion travels along the front surface 904a and reaches the guide part 804 whose the leading edge 804b is positioned within the groove part 900, as described above. Therefore, if the distance between the wall surface 900a, which is on the upstream side of the groove part 900 in the conveyance direction, on the one side in the scanning direction, and on the other side in the scanning direction, and the leading edge 804b is too far, the leading edge Mt may enter between the wall surface 900a and the leading edge 804b, depending on the degree of curling. Therefore, for example, in the groove part 900, the wall surface 900a and the leading edge 804b are designed to abut on each other. Alternatively, the wall surface 900a and the leading edge 804b may be separated in the direction of the relative movement by a predetermined distance based on the curl tolerance level, so that the leading edge Mt, upon reaching the groove part 900 after traveling along the front surface 904a, does not enter the groove part 900.

Further, the inclination angle D2 (See FIG. 8B) of the guide part 804 relative to the flat part 802 is an angle that allows the leading edge Mt of the print medium M to be guided between the cover member 800 and the support part 16 after the leading edge Mt comes into contact with the guide surface 804a. Specifically, for example, D2 is formed so that, at the time the leading edge Mt abuts on the guide surface 804a after traveling along the front surface 904a, the angle θ made by the guide surface 804a and the curled leading edge portion is an obtuse angle. Note that, in a case where the guide surface 804a is a curved surface, for example, D2 is formed so that the angle made by the leading edge portion and the tangent line at the contact position (and in its vicinity) of the leading edge Mt and the guide surface 804a is an obtuse angle. Therefore, the length of the guide part 804 accommodated in the groove part 900 is set to a predetermined length that satisfies the above-described conditions and allows the leading edge Mt of the print medium M to abut on the guide surface 804a at the time the leading edge Mt enters the groove part 900 after traveling along the front surface 904a.

As a result, with the liquid ejection head 714, even if the leading edge portion of the print medium M is curled, the guide part 804 smoothly guides the print medium M from the leading edge Mt into the space between the liquid ejection head 714 (the cover member 800) and the support part 16. This makes it possible to suppress jamming caused by the print medium M during conveyance of the print medium M and during scanning by the liquid ejection head 714, and printing stoppages due to jamming are less likely to occur during printing operations. Further, in the present embodiment, the groove part 900 is provided at a position corresponding to the guide part 804 of the cover member 800 of each of the four printing element substrates 202 installed in a staggered arrangement. Therefore, after passing through the printing element substrates 202 positioned on the upstream side in the direction of the relative movement, even if the curl of the leading edge portion of the print medium M continues to be maintained, jamming can also be suppressed at the printing element substrates 202 positioned on the downstream side in the direction of the relative movement.

### <Functional Effect>

As explained above, on the upstream side of the cover member 800 in the conveyance direction, the one side in the scanning direction, and the other side in the scanning direction, the liquid ejection head 714 is equipped with the guide part 804, with which the leading edge Mt of the print medium M whose leading edge portion is curled can be guided into the space made with the support part 16. Further, the leading edge 804b of the guide part 804 is designed to be accommodated in the groove part 900 provided on the front surface 904a of the support member 904 that supports the printing element substrate 202. Accordingly, the leading edge Mt of the curled print medium M is smoothly guided from the front surface 904a of the support member 904 to the support part 16 side via the guide part 804 as it is conveyed and scanned, thereby suppressing the occurrence of jamming.

### Other Embodiments

Note that the above-described embodiments may be modified as shown in the following (1) through (5).
(1) Although, in the above-described embodiments, a groove part capable of accommodating a leading edge of a guide part is provided on the front surface of a support member, there is no such limitation. It is sufficient for the support member to have a configuration where the leading edge of the guide part of the cover member can be accommodated in the support member at the time the cover member is installed on the printing element substrate, and the shape of this configuration is not particularly limited.

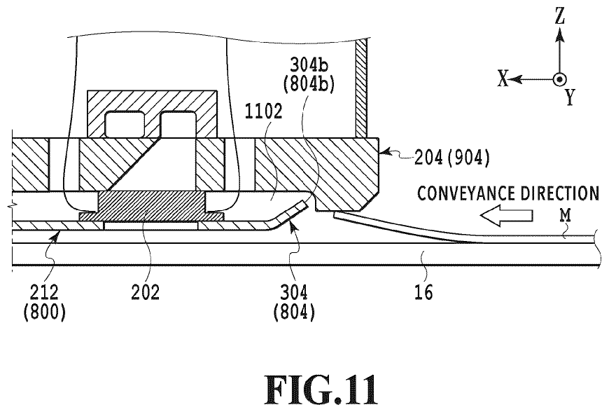

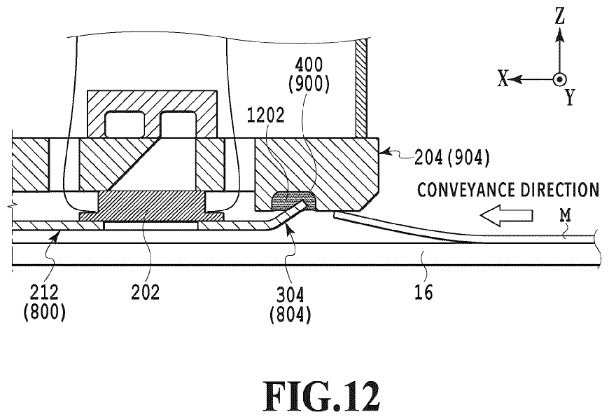

FIG. 11 is a diagram illustrating a modification example of the configuration for accommodating the leading edge of the guide part in the support member. As a configuration different from the groove part 400 (900) for accommodating the leading edge 304b (804b) of the guide part 304 (804) in the support member 204 (904), for example, the recessed part 1102 is provided by widening the support surface 204b (904b) that supports the printing element substrate 202. Further, the leading edge 304b (804b) of the guide part 304 (804) is designed to be accommodated inside this recessed part 1102. In other words, the recessed part 1102 is formed so as to include the support surface 204b. Specifically, for example, the recessed part 1102 has a shape connecting the recessed part 602 (1002) (See FIG. 6A and FIG. 10A), in which the support surface 204b (904b) is formed, and the groove part 400 (900) by removing the partition therebetween.
(2) Although not specifically described in the above embodiments, for example, the resin material 1202 may be placed in the groove part 400 (900) in which the leading edge 304b (804b) is accommodated (See FIG. 12). FIG. 12 is a diagram illustrating the groove part 400 (900) in which the resin material is placed. Note that, in this case, the resin material 1202 placed in the groove part 400 (900) is designed not to protrude from the front surface 204a (904a) of the support member 204 (904). By placing the resin material 1202 in the groove part 400 (900) in which the leading edge 304b (804b) is accommodated, the guide part 304 (804) can be fixed to the support member 204 (904), and thus the cover member 212 (800) can be firmly installed. As a result, even if the print medium M collides with the guide part 304 (804), deformation or damage to the cover member 212 (800) can be suppressed. Further, it is possible to suppress tiny droplets of ink, which are ejected from the printing element substrate 202 but are not applied to the print medium M and instead float in the vicinity, from adhering to electrical components such as the flexible wiring substrate 404 by passing through between the guide part 304 (804) and the support member 204 (904). Note that, if tiny droplets adhere to electrical components, there is a possibility that electrical problems will occur. An epoxy resin, for example, may be used for the resin material 1202. Note that, in a case where this modification (2) is applied to the modification (1), the resin material 1202 is arranged at least between the leading edge 304b (804b) and the wall surface 400a (900a). In this case, the resin material 1202 is to be arranged so as not to protrude from the front surface 204a (904a) of the support member 204 (904).

In a case where the resin material 1202 is placed in the groove part 400 (900), first, the groove part 400 (900) is filled with the resin material 1202. Then, before the resin material 1202 cures, the cover member 212 (800) is attached to the printing element substrate 202, so that the leading edge 304b (804b) of the guide part 304 (804) is accommodated inside the groove part 400 (900) where the resin material 1202 is placed. Thereafter, the resin material 1202 is cured. Alternatively, first, the cover member 212 (800) is attached to the printing element substrate 202, so that the leading edge 304b (804b) of the guide part 304 (804) is accommodated inside the groove part 400 (900) where the resin material 1202 is not placed. Thereafter, the groove part 400 (900) which is accommodating the leading edge 304b (804b) is filled with the resin material 1202, and the resin material 1202 is cured.
(3) In the above-described first embodiment, the guide part 304 is installed only on the upstream side of the cover member 212 in the conveyance direction, but there is no such limitation. For example, the guide part 304 may be installed not only on the upstream side in the conveyance direction but also on the downstream side in the conveyance direction. The guide part 304 to be installed on the downstream side in the conveyance direction is formed so as to gradually incline in the +Z direction toward the downstream side in the conveyance direction. This makes the cover member 212 have a symmetrical shape on the upstream side and the downstream side in the conveyance direction, which improves the shape stability and the rigidity of the cover member 212. Note that, in this case, the front surface 204a of the support member 204 is shaped so as to be capable of accommodating the leading edge 304b of the guide part 304 as the cover member 212 is installed on the printing element substrate 202, for example by providing the groove part 400 on the downstream side of the printing element substrate 202 in the conveyance direction as well.
(4) In the above-described second embodiment, the guide part 804 is installed on the upstream side in the conveyance direction, the one side in the scanning direction, and the other side in the scanning direction of the cover member 800, but there is no such limitation. For example, the guide parts 804 may also be installed on the downstream side in the conveyance direction. That is, in this case, the guide part 804 is installed so as to surround the four sides of the flat part 802. This improves the symmetry of the cover member 800, the shape stability, and the rigidity of the cover member 800. Note that, in this case, the front surface 904a is shaped so as to be capable of accommodating the leading edge 804b of the guide part 804 as the cover member 800 is installed on the printing element substrate 202, for example by providing the groove part 900 on the downstream side of the printing element substrate 202 in the conveyance direction as well.
(5) The above-described embodiments and various forms shown in (1) through (4) may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-059534, filed Apr. 2, 2024, which is hereby incorporated by reference wherein in its entirety.

What is claimed is:

1. A liquid ejection head comprising:
an element substrate configured to eject liquid from ejection ports;
a support member configured to support the element substrate; and
a cover member configured to cover the element substrate,
wherein the cover member includes
a flat part equipped with an opening through which the ejection ports are exposed to the outside, and
an inclined part provided on at least one side of the flat part so as to incline toward the support member as the inclined part extends away from the flat part, and
wherein the support member includes a recessed part configured to accommodate a leading edge of the inclined part.

2. The liquid ejection head according to claim 1,
wherein, in a state where the liquid ejection head is mounted in a liquid ejection apparatus that ejects liquid for printing onto a print medium being conveyed from the liquid ejection head positionally corresponding to a direction intersecting with a conveyance direction of the print medium, the inclined part is formed on an upstream side in the conveyance direction.

3. The liquid ejection head according to claim 2,
wherein the inclined part is formed on a downstream side in the conveyance direction as well.

4. The liquid ejection head according to claim 2,
wherein a plurality of the element substrates is arrayed along the conveyance direction.

5. The liquid ejection head according to claim 1,
wherein, in a state where the liquid ejection head is mounted in a liquid ejection apparatus that ejects liquid for printing onto a print medium being conveyed from the liquid ejection head as the liquid ejection head scans in a direction intersecting with a conveyance direction of the print medium, the inclined part is formed on an upstream side in the conveyance direction, one side in a scanning direction of the liquid ejection head, and the other side in the scanning direction.

6. The liquid ejection head according to claim 5,
wherein the inclined part is formed on a downstream side in the conveyance direction as well.

7. The liquid ejection head according to claim 5,
wherein a plurality of the element substrates is arrayed along the conveyance direction and the scanning direction.

8. The liquid ejection head according to claim 2,
wherein, of the inclined part, a surface that the print medium may abut on is a flat surface or a curved surface.

9. The liquid ejection head according to claim 2,
wherein the leading edge of the inclined part abuts on a wall surface of the recessed part.

10. The liquid ejection head according to claim 2,
wherein the leading edge of the inclined part is separated from a wall surface of the recessed part by a predetermined distance where a curled leading edge portion of the print medium does not enter between the wall surface and the inclined part.

11. The liquid ejection head according to claim 2,
wherein the inclined part is inclined relative to the flat part such that an angle formed by a surface of the inclined part that the conveyed print medium may abut on and a curled leading edge portion of the print medium is an obtuse angle.

12. The liquid ejection head according to claim 2,
wherein the liquid ejection apparatus includes a support part that supports the conveyed print medium, and
wherein the recessed part is formed on a surface of the support member facing the support part.

13. The liquid ejection head according to claim 1,
wherein the cover member is formed of metal.

14. The liquid ejection head according to claim 1,
wherein the recessed part has a groove shape.

15. The liquid ejection head according to claim 1,
wherein the recessed part includes a support surface that supports the element substrate.

16. The liquid ejection head according to claim 1,
wherein a resin material is arranged in the recessed part.

17. A liquid ejection apparatus comprising:
a conveyance unit configured to convey a print medium; and
a liquid ejection head arranged so as to correspond to a length of the print medium conveyed by the conveyance unit in a width direction intersecting with a conveyance direction,
wherein the liquid ejection head includes
an element substrate configured to eject liquid from ejection ports,
a support member configured to support the element substrate, and
a cover member configured to cover the element substrate,
wherein the cover member includes
a flat part equipped with an opening through which the ejection ports are exposed to the outside, and
an inclined part provided on at least one side of the flat part so as to incline toward the support member as the inclined part extends away from the flat part, and
wherein the support member includes a recessed part configured to accommodate a leading edge of the inclined part.

18. A liquid ejection apparatus comprising:
a conveyance unit configured to convey a print medium; and
a liquid ejection head configured to perform scanning in a direction intersecting with a conveyance direction of the print medium conveyed by the conveyance unit,
wherein the liquid ejection head includes
an element substrate configured to eject liquid from ejection ports,
a support member configured to support the element substrate, and
a cover member configured to cover the element substrate,
wherein the cover member includes
a flat part equipped with an opening through which the ejection ports are exposed to the outside, and
an inclined part provided on at least one side of the flat part so as to incline toward the support member as the inclined part extends away from the flat part, and
wherein the support member includes a recessed part configured to accommodate a leading edge of the inclined part.
